(19) United States
(12) Patent Application Publication
(10) Pub. No.: US 2017/0059031 A1
(43) Pub. Date: Mar. 2, 2017

(54) Supply System, in Particular for Gear Mechanisms and Generators

(71) Applicant: ROBERT BOSCH GMBH, Stuttgart (DE)

(72) Inventors: Ibrahim Doertoluk, Krombach (DE); Klaus Ulrich, Iserlohn (DE); Bernd Schnurr, Lohr-Sendelbach (DE); Matthias Oppelt, Schonungen (DE); Udo Froehlich, Rothenfels (DE)

(21) Appl. No.: 14/901,286

(22) PCT Filed: Jun. 10, 2014
(86) PCT No.: PCT/EP2014/061952

§ 371 Date: Nov. 8, 2016

(30) Foreign Application Priority Data
Jul. 3, 2013 (DE) 10 2013 011 090.4
Feb. 5, 2014 (DE) 10 2014 002 869.0

(51) Int. Cl. F16H 57/04; F03D 80/70

(52) U.S. Cl. CPC F16H 57/0442; F16H 57/0436; F16H 57/0435; F16H 57/045; F16H 57/0456; F03D 80/70; F05B 2260/98

(57) ABSTRACT

A lubricating system has been disclosed for gear mechanisms or generators, in particular for gear mechanisms of wind power plants, which lubricating system permits a switchover between dry sump lubrication and wet sump lubrication. This takes place by way of a delivery device which increases the pressure in a lubricant tank selectively or in an emergency, for example a power outage, and presses a lubricant back into an oil sump in the gear mechanism, whereupon a lubricant level is increased there and wet sump lubrication is realized. The delivery device can have a compressor. Said compressor can charge a pressure accumulator via a non-return valve or can increase the pressure in the lubricant tank directly. The delivery device can consist of hydraulic, pneumatic or else electrical components. If it is pneumatic, it can be separated from the hydraulic lubricating system via an elbow.

### A. APPLICATION

The present invention relates to a supply system for coolant and/or lubricant, in particular for gear mechanisms and generators.

### I. DESCRIPTION

Prior Art

Gear mechanisms are among the most highly stressed components of large-scale installations, in particular also wind power plants. They must withstand extreme torques, vibrations and climatic conditions. At the same time, the gear mechanisms must be as efficient as possible.

For this reason, the demands on the components attached to the gear mechanism are also increasing. Among these components are the supply systems, e.g. those for coolants and/or lubricants. They ensure the lubrication of bearings and gearwheels of the gear mechanism. The lubricating system thus reduces wear and friction and increases the service life and load capacity of the components of the gear mechanism.

Using dry sump lubrication, it is possible to minimize splash losses in the gear mechanism in normal operation. In this way, higher efficiency is achieved than with wet sump lubrication or circulating lubrication under pressure. However, wet sump lubrication is less prone to faults.

Publication WO 2009/147147 then discloses a lubricating system for gear mechanisms, in which, in addition to a lubricant tank for supplying a pump for dry sump lubrication of the gear mechanism, there is also a second lubricant tank, in which the prevailing pressure is higher. In an emergency mode, e.g. in the case of a power failure, the pump can no longer supply the gear mechanism with lubricant from the first lubricant tank. The changing pressure conditions in the lubricant lines are measured, and a valve between the second lubricant tank and the gear mechanism opens. Owing to the elevated pressure in the second lubricant tank, lubricant is forced into the gear mechanism, which is provided with wet sump lubrication in this way and is not damaged. As an alternative, the second lubricant tank can also be geodetically higher than the gear mechanism and can supply the gear mechanism with lubricant by means of hydrostatic pressure in the emergency mode.

The disadvantage here is the need to provide additional installation space for a second lubricant tank.

Publication WO 2011/048183 furthermore discloses a lubricating system for gear mechanisms in which a lubricant tank is connected to a vacuum pump. This vacuum pump ensures that the pressure in the lubricant tank is lower in normal operation than in the gear mechanism, thus ensuring that the lubricant flows from the gear mechanism into the lubricant tank and dry sump lubrication is achieved.

In the emergency mode, the vacuum pump is switched off. This leads to an increase in the pressure in the lubricant tank to atmospheric pressure, whereupon lubricant flows from the lubricant tank into the gear mechanism and wet sump lubrication is achieved.

The disadvantage here is the need to integrate a vacuum generator into the lubricating system.

Object of the Invention

It is the object of the present invention to specify an improved supply system for a machine, e.g. a gear mechanism or generator.

Solution

The object according to the invention is achieved by a supply system in accordance with the features of patent claim 1.

Advantages of the Invention

By means of the additional second delivery device, which can likewise deliver coolant or lubricant from the tank into the machine if an operating power supply fails, a supply which produces dry sump operation in normal operation and is suitable for flooding the machine with coolant and/or lubricant in an emergency in order to produce emergency cooling/emergency lubrication is achieved in a reliable manner. Only a single tank is required. The second delivery device allows high flexibility in the technical embodiment and structural arrangement.

The elimination of a vacuum pump, in particular, makes the lubricating system according to the invention significantly more energy-efficient than known lubricating systems according to the prior art, see above.

Depending on the application, the optimum lubricant level and hence also the optimum efficiency is achieved with the minimum splash losses in the gear mechanism, without a reduction in the service life or load capacity of the components.

Advantageous developments of the invention form the subject matter of the dependent claims.

A redundant lubricant supply to the lubricant circuit with the aid of a second, electrically operated pump is also advantageous.

In normal operation, the first delivery device can pump the lubricant out of the lubricant tank through a lubricant circuit by means of a pump coupled to the gear mechanism, for example.

Switching over to the mode referred to as the emergency mode in this document is not only worthwhile when there is an emergency, e.g. a failure of the power supply. If the lubricating system according to the invention is being used to lubricate the gear mechanism of a wind power plant, for example, wet sump lubrication of the gear mechanism may sometimes be more economical for the plant operator. In what is referred to as an idling mode, or when the wind power plant is temporarily not being used to generate power in a manner as far as possible optimized for efficiency, it can likewise switch to the emergency mode and thus lower the energy consumption of the plant.

The second delivery device according to the invention, which is connected to the lubricant tank, can have a pressure accumulator and/or a compressor.

According to a first advantageous embodiment of the invention, the second delivery device has a pneumatic pressure accumulator and a compressor. On the one hand, the compressor can be used to increase the pressure in the lubricant tank and the lubricant level in the gear mechanism and, on the other hand, can be used to charge the pressure accumulator after the latter has increased the pressure in the lubricant tank. To this extent, the structure for increasing pressure in the lubricant tank is advantageously redundant. The second variant finds practical application particularly where it has temporarily been impossible to increase the pressure in the lubricant tank by means of the compressor and therefore the pressure accumulator has intervened. By way of example, this could occur when the compressor is driven by an electric motor and the energy supply suddenly fails.

According to a second, particularly simple embodiment of the invention, the second delivery device comprises a pneumatic pressure accumulator, e.g. in the form of a gas cylinder. After emptying, the pressure accumulator must be replaced or manually recharged. The simple and space-saving embodiment of the second delivery device is advantageous here.

According to a third advantageous embodiment of the invention, the second delivery device comprises a hydraulic pressure accumulator which, like the gear mechanism, is connected hydraulically to the lubricant tank. The hydraulic pressure accumulator is charged, for example, by means of the different displacements of two hydraulic motors of different sizes, which can be driven by the lubricant volume flow from the lubricant circuit, for example.

### FIGURES

A first embodiment according to the invention of the supply system, having a first delivery device for delivering lubricant in a normal mode and having a pneumatic second delivery device, is illustrated in

FIG. 2 shows a detail of the second delivery device in accordance with a second embodiment according to the invention.

A third embodiment according to the invention, having a second delivery device with a hydraulic accumulator, can be seen in FIG. 3.

The essential components of the arrangement illustrated in FIG. 1 are the gear mechanism 1 with its oil sump 14, and a closed lubricant tank 2. In the normal mode, a valve 3 and a valve 8 are powered. The lubricating system is relieved to atmosphere via valve 8, with the result that the lubricant flows into the lubricant tank from the oil sump 14 of the gear mechanism 1 by virtue of a geodetic difference in level ΔH in the illustrative embodiment under consideration. Other ways of achieving this are known. As a result, the gear mechanism 1 switches to dry sump lubrication in a normal mode. In this case, a mechanical pump 4, coupled to the gear mechanism 1, and an electric pump 5 ensure the lubrication of the gear mechanism 1. A filter 6 filters the lubricant before it enters the gear mechanism.

In order to switch to wet sump lubrication, the lubricant tank 2 can be put under pressure by means of valve 8, using a compressor 11, a valve 9 or a pressure accumulator 10, thereby forcing the lubricant back into the gear mechanism 1. During this process, valve 3 and valve 8 are not powered. A lubricant level in the gear mechanism can also be regulated by way of the operating time of valve 8, if appropriate. Uncontrolled discharge of the pressure accumulator 10 is prevented by a restrictor 12. If the electric energy supply fails, the lubricant is likewise forced back into the gear mechanism 1 by means of the pressure accumulator 10, which is precharged by the compressor 11. Adequate lubrication in the event of a power failure is thus ensured. During these processes, valve 3 prevents unwanted return of the lubricant to the lubricant tank. A pipe elbow 7 separates the hydraulics from the pneumatics. The pressure accumulator 10 can be recharged at any time by the compressor 11 by way of a check valve 13.

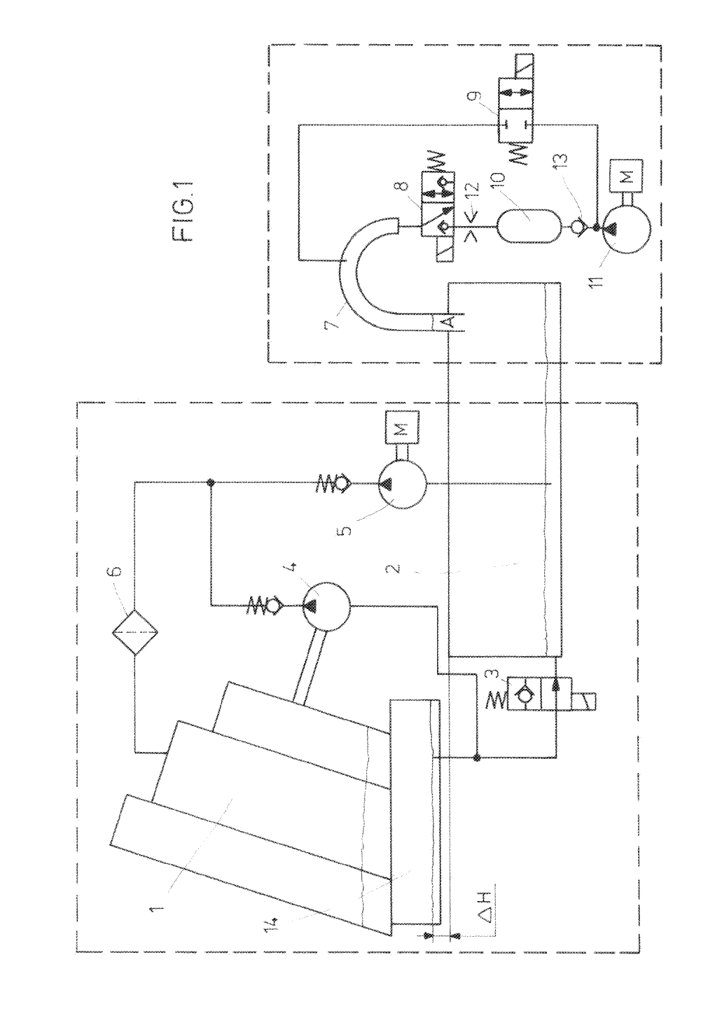

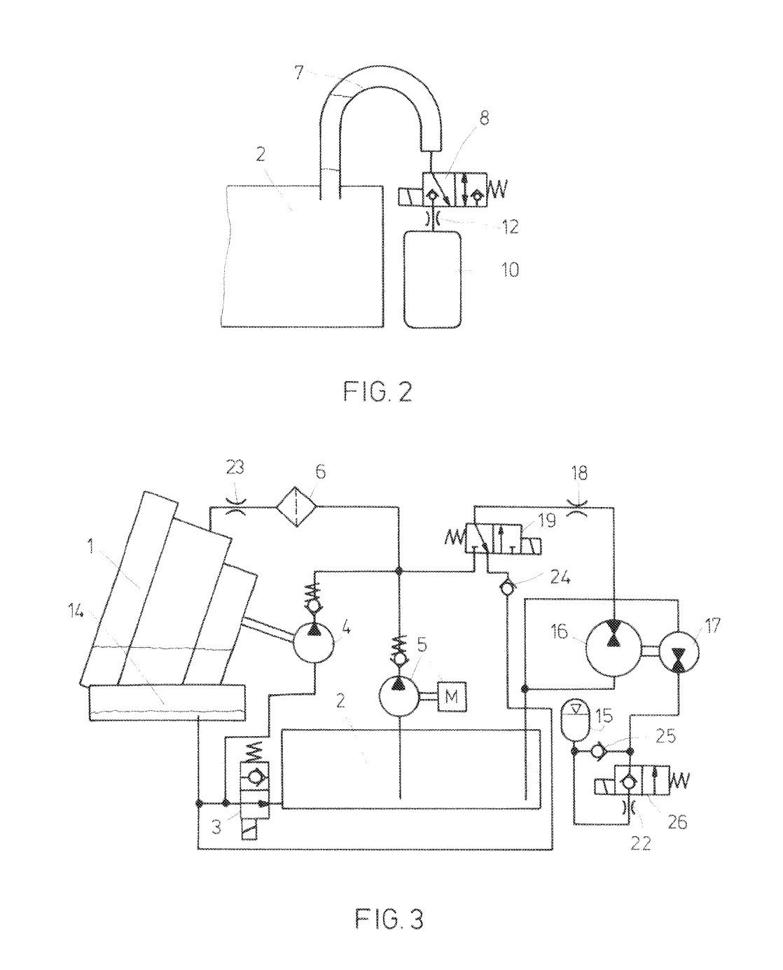

The second embodiment according to the invention uses a simplified second delivery device, which can be seen in FIG. 2. The compressor 11 has been dispensed with. This solution is suitable only for a limited number of occasions of flooding the gear mechanism 1 with lubricant, e.g. only if the power fails. The pressure accumulator 10 or gas cylinder 10 may have to be replaced or refilled in order to restart the gear mechanism 1.

The embodiment shown in FIG. 3 uses a second delivery device having a hydraulic accumulator 15 and hydraulic motors 16, 17. The hydraulic accumulator 15 is charged via the check valve 25 and valve 26 by virtue of the different displacements of the hydraulic motors 16, 17. In this process, the large hydraulic motor 16 acts as a drive, which is set in motion by the pressure and volume flow of the lubricating circuit. The smaller of the two hydraulic motors 17 charges the hydraulic accumulator 15. Restrictors 18 and 23 ensure adequate lubrication of the gear mechanism during the charging process by distributing the volume flow by means of the backpressure. If the power fails or if the intention is to raise the lubricant level in the gear mechanism 1, none of valves 3, 19, 26 is powered. By means of the energy from the hydraulic accumulator 15, the small hydraulic motor 17 then drives the large hydraulic motor 16, which, in turn, delivers the lubricant from the lubricant tank 2 back into the gear mechanism 1 via a check valve 24. Restrictor 22 controls the speed of the discharge process. The remainder of the structure of the supply system corresponds to the first embodiment according to the invention illustrated in FIG. 1.

As an option, there is also the possibility of supplementing the hydraulic delivery device by means of an electric motor/pump unit similar to 5. For emergency lubrication in the event of a power failure, this should be provided with an electric accumulator unit.

### II LIST OF REFERENCE SIGNS

1. gear mechanism

2 lubricant tank

3 valve

4 mechanical pump coupled to the gear mechanism

5 electric pump

6 filter

7 pipe elbow

8 valve

9 valve

10 pressure accumulator

11 compressor

12 restrictor

13 check valve

14 oil sump of the gear mechanism

15 hydraulic accumulator

16 large hydraulic motor

17 small hydraulic motor

18 restrictor

22 restrictor

23 restrictor

24 check valve

25 check valve

26 valve

1. A supply system for coolant and/or lubricant for a machine, comprising:
a body that defines a space configured to hold at least one of coolant and lubricant;
a tank positioned in a vicinity of the machine;
a first delivery device configured to deliver at least one of coolant and lubricant from the tank to cooling and lubrication points of the machine, respectively;
a fluid line configured to drain at least one of coolant and lubricant from the space of the body into the tank; and
a second delivery device that is positioned and configured to deliver at least one of coolant and lubricant from said tank into the machine, and that includes an energy storage device that enables operation of the second delivery device for at least a certain time independently of an operating power supply.

2. The supply system as claimed in claim 1, wherein the energy storage device of the second delivery device is a pressure accumulator.

3. The supply system as claimed in claim 2, wherein the pressure accumulator is a pneumatic gas accumulator that includes:
a pneumatic connecting line extending from the gas accumulator to the tank; and
a second valve that is positioned in the pneumatic connecting line, and that is configured to open the pneumatic connecting in response to a failure of the operating power supply.

4. The supply system as claimed in claim 3, wherein the pneumatic connecting line has a pipe elbow between the second valve and the tank.

5. The supply system as claimed in claim 3, wherein the second delivery device further includes a pneumatic compressor configured to charge the gas accumulator.

6. The supply system as claimed in claim 3, wherein the pneumatic connecting line has a restrictor between the gas accumulator and the tank.

7. The supply system as claimed in claim 2, further comprising:
a pump configured to deliver at least one of coolant and lubricant from the tank into the machine;
a hydraulic motor configured to drive the pump; and
a third valve configured to open the pneumatic connecting line in response to a failure of the operating power supply;
wherein the pressure accumulator is a hydraulic accumulator that is connected to the hydraulic motor, and to the third valve.

8. The supply system as claimed in claim 7, further comprising:
a fourth valve configured to feed at least one of coolant and lubricant to the pump from the first delivery device in order to charge the hydraulic accumulator in a reverse mode of the pump and of the hydraulic motor.

9. The supply system as claimed in claim 1, wherein:
the energy storage device is an electric energy storage device; and
the second delivery device is configured as an electric motor unit or as an electric pump.

10. The supply system as claimed in claim 1, wherein the tank is positioned at a geodetic height below the space of the body.

11. The supply system as claimed in claim 1, wherein the second delivery device further includes a valve that is positioned in the fluid line, and that is configured to shut off the fluid line in response to a failure of the operating power supply.

12. The supply system as claimed in claim 6, wherein:
the second delivery device further includes a valve that is positioned in the fluid line, and that is configured to shut off the fluid line in response to a failure of the operating power supply; and
the restrictor is between the gas accumulator and the valve.
